(19) United States
(12) Patent Application Publication
(10) Pub. No.: US 2004/0017084 A1
(43) Pub. Date: Jan. 29, 2004

(54) Pipe fitting

(75) Inventors: Kenichi Konno, Tokyo (JP); Sachio Koyama, Tokyo (JP); Hiromi Takasaki, Tokyo (JP)

Correspondence Address: FOLEY AND LARDNER, SUITE 500, 3000 K STREET NW, WASHINGTON, DC, 20007, US

(73) Assignee: CALSONIC KANSEI CORPORATION

(21) Appl. No.: 10/445,893

(22) Filed: May 28, 2003

(30) Foreign Application Priority Data
May 29, 2002 (JP) 2002-156381
Oct. 15, 2002 (JP) 2002-300761

(51) Int. Cl. F16L 21/00

(52) U.S. Cl. 285/403

(57) ABSTRACT

A pipe fitting 10 is used for connecting a large-diameter pipe and a small-diameter pipe each having a flange portion at pipe end. The pipe fitting 10 includes a pair of side pieces 12, a connecting piece 11 and a support portion 15. The side pieces 12 are disposed to face each other, and each has a fitting hole portion 13 in which the flange portions are to be inserted in a state in which the large-diameter pipe and the small-diameter pipe are connected. The connecting piece connects the side pieces 12 at each of end portions. The support portion 15 is formed at each side pieces 12 in a manner to be orthogonal to the side pieces 12 and to be faced each other.

The present disclosure relates to the subject matter contained in Japanese Patent Application No. 2002-156381 filed on May 29, 2002, and in Japanese Patent Application No. 2002-300761 filed on Oct. 15, 2002, which are incorporated herein by reference in its entirety.

### BACKGROUND OF THE INVENTION

1. Field of the Invention

The present invention relates to a pipe fitting that connects two pipes of different diameters, and in particular to a pipe fitting structure that is easily molded when being integrally formed by pressing.

2. Description of the Related Art

Conventionally, with respect to this type of pipe fitting 70, structures have been proposed in which, for example, as shown in FIG. 9, a rectangular spring portion 71 serves as a head portion, arced portions 72, in centers of which having punched rectangular opening portions 73, are connected to both sides of the spring portion 71, and guide portions 74, formed by folding lower ends of the arced portions 72 outward, are disposed. In order to use the pipe fitting 70 to connect two pipes of different diameters, the pipe fitting 70 is formed so that diameters of arc pieces 72a and 72b of the arced portions 72 differ at the left and right of the rectangular opening portions 73 and so that end portion shapes and disposed positions of the spring portion 71 and the guide portions 74 connected to the arced portions 72 also differ at the left and right of the rectangular opening portions 73 (e.g., see JP-A-2001-099376).

When two pipes are to be connected using the pipe fitting 70 of the above-described structure, as shown in FIG. 10, a large-diameter pipe 80 that includes a flange portion 81 and a small-diameter pipe 90 that includes a flange portion 91 are brought into contact, the portions at which the flanges contact are inserted through the pipe fitting 70 from the guide portions 74 so that the portions at which the flanges contact are fitted into the rectangular opening portions 73, the large-diameter arc pieces 72a of the arced portions 72 support the large-diameter pipe 80 and the small-diameter arc pieces 72b support the small-diameter pipe 90, whereby the state of contact is maintained.

However, because the pipe fitting 70 is formed so that the diameters of the arc pieces of the arced portions 72 differ at the left and right of the rectangular opening portions 73, the pipe fitting 70 becomes a twisted three-dimensional shape when it is integrally formed by pressing from a metal plate, and there has been the problem that sometimes each pipe cannot be reliably supported due to the arced portions 72 (the large-diameter arc pieces 72a and the small-diameter arc pieces 72b) bending.

That is, when the arced portions 72 (the large-diameter arc pieces 72a and the small-diameter arc pieces 72b) are formed by pressing, although the developed lengths of the large-diameter arc pieces 72a and the small-diameter arc pieces 72b are the same prior to pressing (FIG. 11A), because the curvatures of the formed arcs are different, when they are bent at the same time, the length L of the large curvature becomes shorter (FIG. 11B), the entire portion is pulled toward the large-diameter piece 72a (toward the side at which L is small) (FIG. 11C) and, as a result, twisting is generated in the fixed fitting.

When the step between the diameters of the two pipes for which the fixed fitting 70 is used is small, large twisting is not generated in the arced portions 72. However, there has been the problem that twisting becomes remarkable when the step becomes larger, and the pipe fitting 70 no longer functions as a product.

### SUMMARY OF THE INVENTION

The present invention was devised in light of the above-described circumstances, and it is an object thereof to obtain a structure, in a pipe fitting that is integrally formed by pressing a metal plate, and can reliably support each pipe in regard to connecting two pipes of different diameters.

In order to achieve the object, according to a first aspect of the invention, there is provided a pipe fitting for connecting a large-diameter pipe and a small-diameter pipe each having a flange portion at pipe end, including: a pair of side pieces disposed to face each other, and each having a fitting hole portion in which the flange portions are to be inserted in a state in which the large-diameter pipe and the small-diameter pipe are connected; a connecting piece connecting the side pieces at each of end portions; and a support portion adapted to support the small-diameter pipe, and being formed at each side pieces in a manner to be orthogonal to the side pieces and to be faced each other, wherein the connecting piece is positioned at the side where the end portions of the side pieces are formed and in a plane in which the support portions are disposed, wherein the sidepieces, the connecting piece and the support portion are integrally formed.

According to a second aspect of the invention, there is provided a pipe fitting for connecting a large-diameter pipe and a small-diameter pipe each having a flange portion at pipe end, including: a pair of side pieces disposed to face each other, and each having a fitting hole portion in which the flange portions are to be inserted in a state in which the large-diameter pipe and the small-diameter pipe are connected; a connecting piece connecting the side pieces at each of end portions; and a support portion adapted to support the small-diameter pipe, and being formed at each side pieces in a manner to be orthogonal to the side pieces and to be faced each other, wherein the connecting piece connects the side pieces at a plane orthogonal to the support portions, wherein the sidepieces, the connecting piece and the support portion are integrally formed.

According to the invention, when the pipe fitting is fitted to a portion at which a large-diameter pipe and a small-diameter are connected, the pipe fitting has a spring action due to the side pieces and the connecting piece, the large-diameter pipe is supported by the pair of side pieces that are disposed so as to face each other, and the large-diameter pipe is supported by the side walls of the arced support portions that are disposed so that they are folded orthogonally to the side pieces. Thus, twisting does not arise in the integrally formed pipe fitting, and the pipe fitting can reliably support the pipes.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a perspective explanatory drawing of a pipe fitting of an example of an embodiment of the invention;

FIG. 2 is a plan explanatory drawing showing a developed state, prior to pressing, of the pipe fitting;

FIGS. 3A and 3B are drawings showing the pipe fitting, wherein FIG. 3A being a front explanatory drawing and FIG. 3B being a side explanatory drawing;

FIG. 4 is a connection side explanatory drawing showing a connected structure when the pipe fitting is fitted to a portion at which a large-diameter pipe and a small-diameter pipe are connected;

FIG. 5 is a perspective explanatory drawing of a pipe fitting showing another example of the embodiment of the invention;

FIG. 6 is a perspective explanatory drawing of a pipe fitting showing another example of the embodiment of the invention;

FIGS. 7A and 7B are drawings showing another example of the pipe fitting, wherein FIG. 7A being a front explanatory drawing and FIG. 7B being a side explanatory drawing;

FIGS. 8A and 8B are drawings showing another example of the pipe fitting, wherein FIG. 8A being a front explanatory drawing and FIG. 8B being a side explanatory drawing;

FIG. 9 is a perspective explanatory drawing of a conventional pipe fitting;

FIG. 10 is a connected structure cross-sectional explanatory drawing showing a connected structure when the pipe fitting of FIG. 9 is fitted to a portion at which a large-diameter pipe and a small-diameter pipe are connected; and

FIGS. 11A, 11B and 11C are drawings showing arced portions for describing the reason twisting arises in the conventional pipe fitting, wherein FIG. 11A being a side explanatory drawing prior to pressing, FIG. 11B being a cross-sectional explanatory drawing of each arc piece after pressing, and FIG. 11C being a side explanatory drawing after pressing.

### DETAILED DESCRIPTION OF THE PREFERRED EMBODIMENTS

Referring now to the accompanying drawings, there is shown a preferred embodiment of the invention.

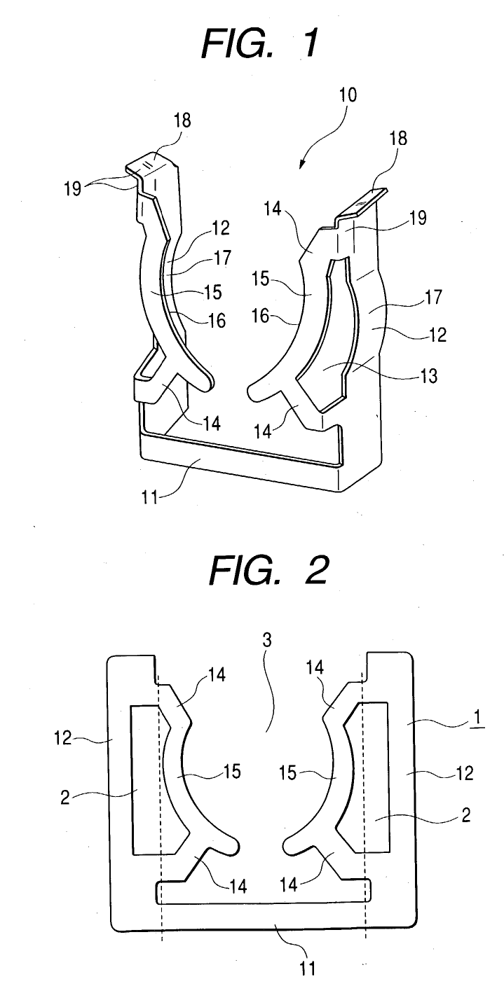

A pipe fitting as an example of an embodiment of the invention will be described with reference to FIGS. 1 to 3B.

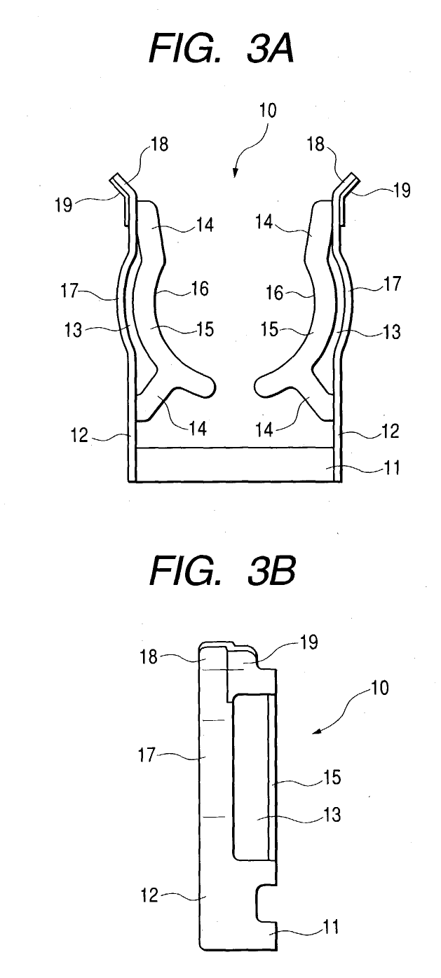

FIG. 1 is a perspective explanatory drawing of the pipe fitting, FIG. 2 is a plan explanatory drawing showing a developed state, prior to pressing, of the pipe fitting, and FIGS. 3A and 3B are a front explanatory drawing and a side explanatory drawing of the pipe fitting.

As shown in FIG. 2, a pipe fitting 10 is integrally formed by pressing a substantially square metal plate 1, in which opening portions 2 and a cutout portion 3 are formed by punching. When the metal plate 1 of FIG. 2 is folded at the dotted line portions to form right angles and pressed to form uneven surfaces in side pieces 12, the metal plate 1 becomes the pipe fitting 10 having a three-dimensional shape such as the one shown in FIG. 1.

That is, the side pieces 12 are folded with respect to a connecting piece 11, which comprises a rectangular piece positioned at a front lower portion of the pipe fitting 10, so that the side pieces 12 are disposed facing each other at both sides of the connecting piece 11. The connecting piece 11 and the side pieces 12 are connected at end portions of the side pieces 12.

A fitting hole portion 13 (opening portions 2 in FIG. 2) is formed in each side piece 12, and arced support portions 15, which are disposed in a plane orthogonal to the side pieces 12 via foot pieces 14, are formed. That is, side wall 16 portions of the arced support portions 15 are disposed so as to face each other by folding the foot pieces 14 so that the foot pieces 14 are orthogonal to each side piece 12. Therefore, because each arced support portion 15 and the connecting piece 11 are folded and formed so that they are all orthogonal to the side pieces 12, they are disposed on the same plane.

When a large-diameter pipe and a small-diameter pipe are to be connected, the arced support portions 15 sandwich the small-diameter pipe from both sides with the side walls 16. Flange portions are insertable into the fitting hole portions 13 of the side pieces 12 in a state in which the large-diameter pipe and the small-diameter pipe are brought into contact and connected.

An arced curved portion 17, which is formed by pressing in a manner that an outer side thereof becomes convex, is disposed in a center portion of each side piece 12 along a position at which the fitting hole portion 13 is formed. When the pipes are connected, the curved portions 17 contact parts of the periphery of the large-diameter pipe and can support the large-diameter pipe.

Folded portions 18, which are folded so as to spread outward, are formed at end portions of the side pieces 12 opposite from the end portions of the side pieces 12 connected to the connecting piece 11. Moreover, guide grooves 19, which are protruded outwward, are formed in the folded portions 18 and at positions to the sides of the fitting holes portions 13 in the side pieces 12 that are continuous with the folded portions 18.

Next, description will be given of a case where two pipes are connected using the pipe fitting 10 of the above-described structure.

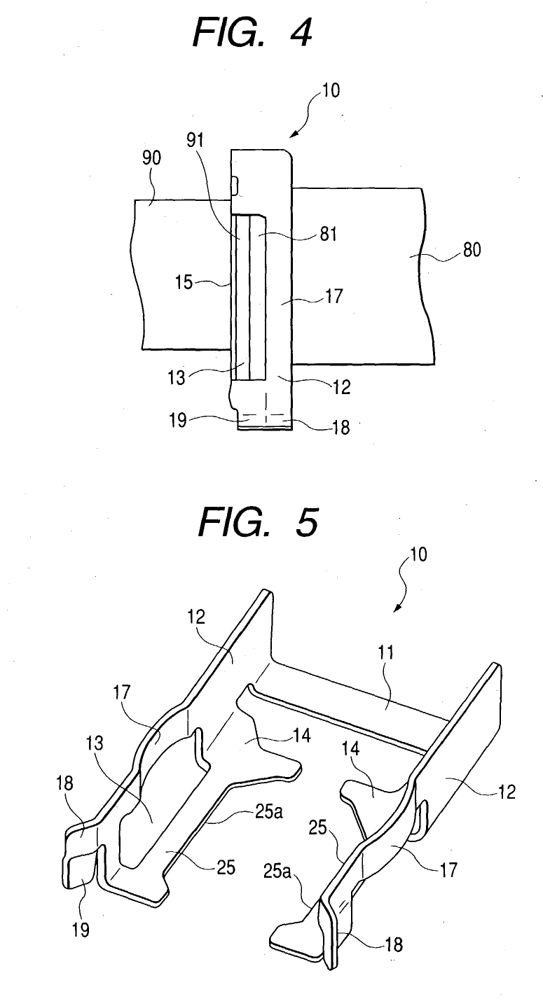

When a large-diameter pipe 80 and a small-diameter pipe 90 are to be connected, as shown in FIG. 4, a flange portion 81 of the large-diameter pipe 80 and a flange portion 91 of the small-diameter pipe 90 are brought into contact, and the portions at which the flange portions contact are inserted through the pipe fitting 10 from the folded portions 18 side. At this time, due to the disposure of the guide grooves 19, the flange portions can easily be inserted through the pipe fitting 10 and the portions at which the flange portions 81 and 91 contact are guided, whereby the flange portions 81 and 91 can be vertically inserted through the pipe fitting 10. Also, due to a spring action in which the connecting piece 11 serves as abase portion, both side pieces 12 widen, whereby the portions at which the flange portions contact are fitted and disposed in the fitting hole portions 13, the side walls 16 support the small-diameter pipe 90, and the curved portions 17 of the side pieces 17 support the large-diameter pipe 80, whereby the contact state is maintained.

FIG. 5 shows another embodiment of the invention, and the same reference numerals will be given to portions that have the same constitution as those in FIG. 1.

The pipe fitting 10 of FIG. 5 is one in which the shape of support portions 25 supporting the small-diameter pipe 90 are different in comparison to those of the pipe fitting 10 of FIG. 1. That is, whereas the arced support portions 15 along the shape of the small-diameter pipe 90 served as the support portions in the pipe fitting 10 of FIG. 1, the support portions 25, which sandwich the small-diameter pipe between straight portions 25a positioned to face each other, are formed. Other configurations are the same as those of the pipe fitting 10 of FIG. 1.

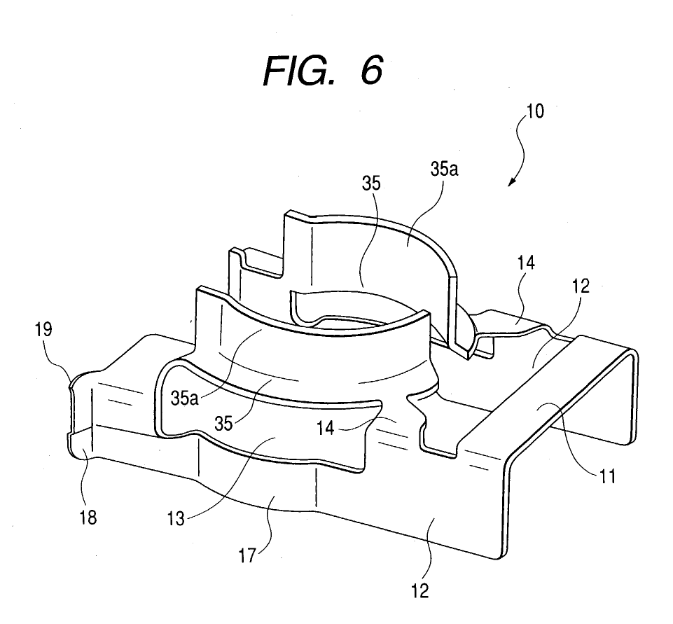

FIG. 6 shows another embodiment of the invention, and the same reference numerals will be given to portions that have the same constitution as those in FIG. 1.

The pipe fitting 10 of FIG. 6 is one in which the shape of support portions 35 supporting the small-diameter pipe 90 are different in comparison to those of the pipe fitting 10 of FIG. 1. That is, a vertical flange portion 35a, which is an arced curved surface vertically disposed across each entire arced support portion 15, is formed at the support side of each arced support portion 15 of the pipe fitting 10 shown in FIG. 1 so that the vertical flange portions 35a face each other and support the small-diameter pipe 90.

The small-diameter pipe 90 can be more reliably supported due to the support portions 35 that include the vertical flange portions 35a.

Other configurations are the same as those of the pipe fitting 10 of FIG. 1.

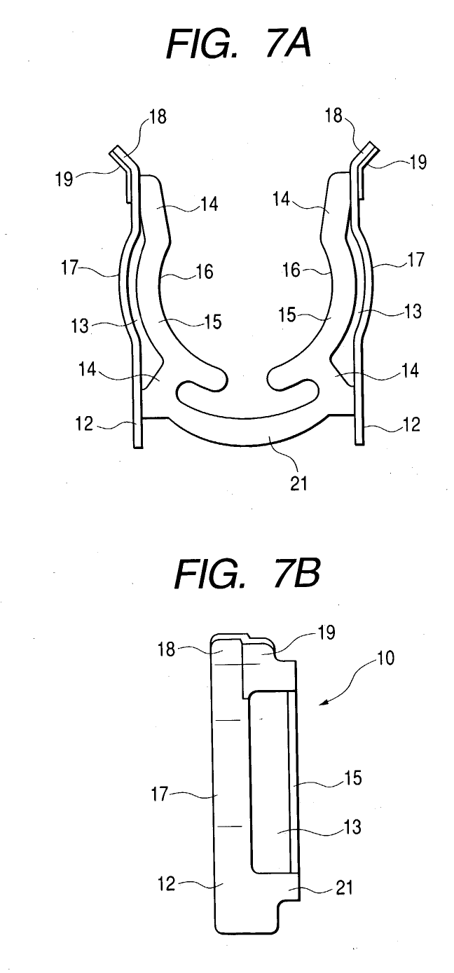

FIGS. 7A and 7B show another embodiment of the invention, and the same reference numerals will be given to portions that have the same constitution as those in FIG. 1.

The pipe fitting 10 of FIGS. 7A and 7B is one in which the shape and formation position of the connecting piece are different in comparison to those of the pipe fitting 10 of FIG. 3. That is, although the connecting piece 11 is disposed at the endmost portion in the same plane as the arced support portions 15 of the side pieces 15 in the pipe fitting 10 of FIG. 3, in this example, the connecting piece is configured by an arced piece 21 that connects positions slightly distanced from the end portions of the side pieces 12. The arced piece 21 is also connected to the foot portions 14.

Due to above described configuration, when the lengths of the side pieces 12 of the pipe fitting 10 in FIGS. 3A, 3B, 7A and 7B are made the same, the distance from the folded portions 18 at the end portions of the side pieces to the spring fulcrum (arced piece 21) becomes shorter in the embodiment of FIGS. 7A and 7B, and the spring constant when the side pieces 12 are spread becomes larger in comparison to the pipe fitting of FIG. 3 (i.e., the pipe fitting can be structured so that the side pieces 12 are difficult to spread).

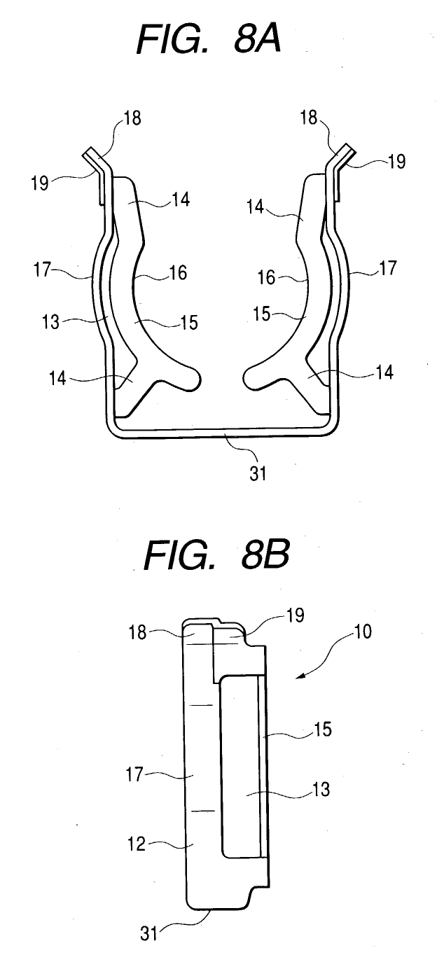

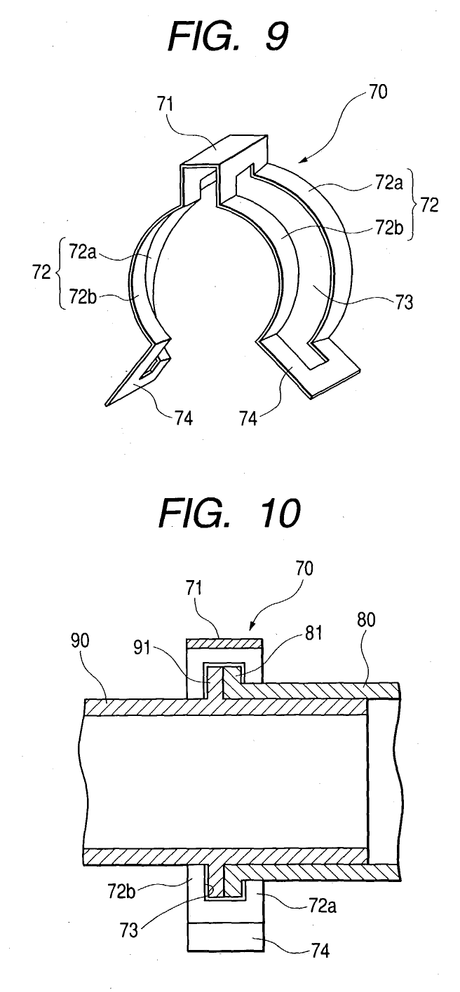

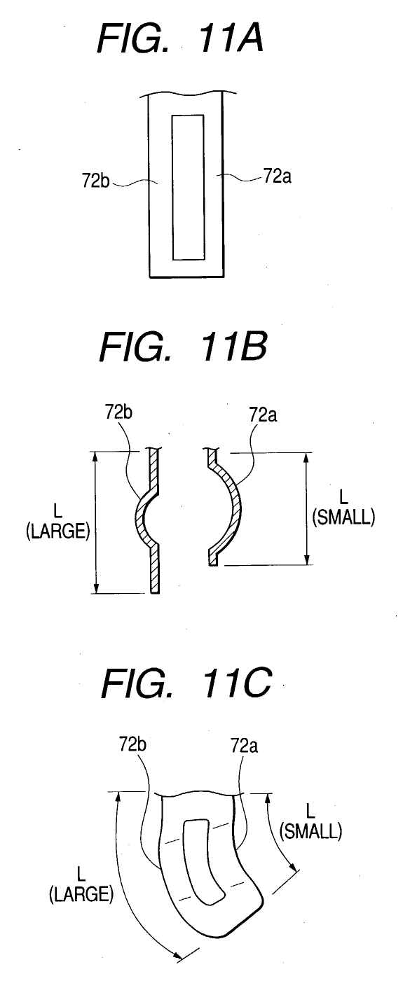

FIGS. 8A and 8B show another embodiment of the invention, and the same reference numerals will be given to portions that have the same constitution as those in FIG. 1.

The pipe fitting 10 of FIGS. 8A and 8B is one in which the position at which the connecting piece is formed with respect to the side pieces 12 is different in comparison to that of the pipe fitting 10 of FIG. 3. That is, in this example, a connecting piece 31 is configured to connect short ends (lower end edges) of the side pieces 12 and is disposed in a plane orthogonal to the arced support portions 15. That is, the connecting piece 31 connects the end portions of the side pieces 12 at a plane orthogonal to the arced support portions 15.

Due to above described configuration, when a force is applied in a direction in which the side pieces 12 are widened, because the force acts directly on both ends of the connecting piece 31 serving as the spring fulcrum, the spring constant is made smaller in comparison to the pipe fitting of FIG. 3 (i.e., the pipe fitting can be structured so that the side pieces 12 are easy to spread).

According to the pipe fitting 10 of each of the aforementioned embodiments, the pipe fitting has a spring action due to the side pieces 12 and the connecting pieces 11 and 31 (arced pieces 21), the large-diameter pipe 80 is supported by the pair of side pieces 12 that are disposed so as to face each other, and the large-diameter pipe 90 is supported by the side walls 16 (straight portions 25a and vertical flange portions 35a) of the arced support portions 15 (support portions 25 and support portions 35) that are disposed so that they are folded orthogonally to the side pieces 12. Thus, the connecting pieces 11 and 31 (arced pieces 21) can be disposed in a plane orthogonal to the side pieces 12. Thus, twisting does not arise in the overall shape of the pipe fitting 10, and the pipe fitting 10 can reliably support the pipes.

Additionally, according to the pipe fitting 10 of each of the aforementioned embodiments, even if the step between the diameters of the pipes that are to be connected is large, the pipes can be accommodated simply by deforming the shape of the arced support portions 15, and twisting does not arise in the pipe fitting 10 as in the conventional example.

Also, because the pipe fitting 10 can be integrally and easily formed by pressing the metal plate 1 to dispose the opening portions 2 and the cutout portions 3, it becomes possible to inexpensively manufacture the pipe fitting 10.

According to the invention, when the pipe fitting is fitted to a portion at which a large-diameter pipe and a small-diameter are connected, the pipe fitting has a spring action due to the side pieces and the connecting piece, the large-diameter pipe is supported by the pair of side pieces that are disposed so as to face each other, and the large-diameter pipe is supported by the side walls of the arced support portions that are disposed so that they are folded orthogonally to the side pieces. Thus, twisting does not arise in the integrally formed pipe fitting, and the pipe fitting can reliably support the pipes.

Also, a pipe fitting that is easily molded when being integrally formed by pressing can be provided.

Although the present invention has been shown and described with reference to specific preferred embodiments, various changes and modifications will be apparent to those skilled in the art from the teachings herein. Such changes and modifications as are obvious are deemed to come within the spirit, scope and contemplation of the invention as defined in the appended claims.

What is claimed is:

1. A pipe fitting for connecting a large-diameter pipe and a small-diameter pipe each having a flange portion at pipe end, comprising:
a pair of side pieces disposed to face each other, and each having a fitting hole portion in which the flange portions are to be inserted in a state in which the large-diameter pipe and the small-diameter pipe are connected;
a connecting piece connecting the side pieces at each of end portions; and
a support portion adapted to support the small-diameter pipe, and being formed at each side pieces in a manner to be orthogonal to the side pieces and to be faced each other,
wherein the connecting piece is positioned at the side where the end portions of the side pieces are formed and in a plane in which the support portions are disposed,
wherein the sidepieces, the connecting piece and the support portion are integrally formed.

2. The pipe fitting as claimed in claim 1, wherein the support portions are arced along a circumference of the small-diameter pipe.

3. The pipe fitting as claimed in claim 1, wherein the connecting piece is formed in a rectangular shape that connects the end portions of the side pieces.

4. The pipe fitting as claimed in claim 1, wherein the connecting piece is formed in an arced shape that connects positions slightly distanced from the end portions of the side pieces.

5. The pipe fitting as claimed in claim 1, further comprising a curved portion formed in a center portion of each side pieces and adapted to be in contact with a circumference of the large-diameter pipe.

6. The pipe fitting as claimed in claim 1, further comprising a folded portion formed at an end portion of each side pieces opposite to the end portion, and protrudes outward.

7. A pipe fitting for connecting a large-diameter pipe and a small-diameter pipe each having a flange portion at pipe end, comprising:
a pair of side pieces disposed to face each other, and each having a fitting hole portion in which the flange portions are to be inserted in a state in which-the large-diameter pipe and the small-diameter pipe are connected;
a connecting piece connecting the side pieces at each of end portions; and
a support portion adapted to support the small-diameter pipe, and being formed at each side pieces in a manner to be orthogonal to the side pieces and to be faced each other,
wherein the connecting piece connects the side pieces at a plane orthogonal to the support portions,
wherein the sidepieces, the connecting piece and the support portion are integrally formed.

8. The pipe fitting as claimed in claim 5, wherein the support portions are arced along a circumference of the small-diameter pipe.

9. The pipe fitting as claimed in claim 5, further comprising a curved portion formed in a center portion of each side pieces and adapted to be in contact with a circumference of the large-diameter pipe.

10. The pipe fitting as claimed in claim 5, further comprising a folded portion formed at an end portion of each side pieces opposite to the end portion, and protrudes outward.
